(19) United States
(12) Patent Application Publication
(10) Pub. No.: US 2026/0310306 A1
(43) Pub. Date: Oct. 8, 2026

(54) BACKLIGHT MODULE FOR FIVE-IN-ONE METAL SUBSTRATE BACKLIGHT AND CONDUCTIVE FILM COMBINED KEYBOARD

(71) Applicant: Shenzhen Hui Chuang Da Technology Co.,Ltd., Shenzhen (CN)

(72) Inventors: JINXIN DING, Shenzhen (CN); MING LI, Shenzhen (CN); JIE FENG, Shenzhen (CN); MENG DING, Shenzhen (CN)

(21) Appl. No.: 18/123,313

(22) Filed: Mar. 19, 2023

(51) Int. Cl. G06F 3/02; F21V 8/00

(52) U.S. Cl. CPC G06F 3/0202; G02B 6/0041; G02B 6/0055

(57) ABSTRACT

A backlight module for keyboard, comprising keycaps, upper conduction components, lower conduction components, LED lights, light shielding film, light guiding film and light reflecting film, the keycap is arranged above the upper conduction component, the lower conduction component is arranged below the upper conduction component, an opening is provided on the lower conduction component, the LED light is arranged under the lower conduction component, the light shielding film is arranged under the lower conduction component, and is provided with a first through hole corresponding to the LED light, the light guiding film is arranged under the light shielding film, which is provided with a second through hole corresponding to the LED light, which is arranged in the first and second through hole, the corresponding openings on the light guiding film are provided with light guiding dots, the light reflecting film is arranged under the light guiding film.

### TECHNICAL FIELD

The present application relates to a backlight module for a keyboard, in particular to a backlight module for a five-in-one metal substrate backlight and a conductive film combined keyboard, which is used in the field of computer accessories.

### BACKGROUND

The keyboard is the most commonly used and most important input device, through which English letters, Chinese characters, numbers, punctuation marks, etc. can be input into the computer, so as to issue commands and input data to the computer. It can be said that since the day when the computer was produced, the keyboard has been one of the indispensable peripheral devices of the computer.

With the continuous development of the keyboard, in order to make the keyboard have a better use effect, a backlit keyboard (or called a luminous keyboard) has emerged as the times require. In the keyboard, the keycap is designed as a light-transmitting structure, and the keycap is illuminated by the light emitted by the backlight module. On the one hand, this is more suitable for typing at night, so that it is easier to see the words on the keycaps, and on the other hand, it will also produce a more cool effect. The light-emitting keyboard structure in the prior art is to arrange a backlight module inside the keyboard, and a metal substrate is arranged under the backlight module, and the backlight module emits light to illuminate the keycap. The backlight module usually comprises a light shielding film, a light guiding film, a light reflecting film and LEDs, wherein the light shielding film, the light guiding film and the light reflecting film are stacked, and the LEDs are arranged on the side of the light-guiding film. The light emitted by the LEDs enters the light guiding film and is guided to each keycap through the light guiding film, thereby illuminating the keycaps.

Currently common backlit keyboards have inherent disadvantages due to their structural limitations: 1) Since the LED light is arranged between the keycap and the backlight module, it is not conducive to the heat dissipation of the backlight module, and it is easy to cause heat concentration, and there is a problem of local heating of the keyboard; 2) The metal substrate is located under the backlight module to support the keycaps. The keycaps of the existing backlight keyboard need to pass through the backlight module to connect with the metal substrate, which makes the structure of the existing backlight keyboard more complicated and is not conducive to the heat dissipation of the backlight keyboard.

### SUMMARY

In view of the problems of complex structure and poor heat dissipation effect of the backlit keyboard mentioned above in the prior art, the present application provides a backlight module for five-in-one metal substrate backlight and conductive film combined keyboard. By using the lower conduction component structure, the metal substrate is located under the keycap, thereby directly supporting the keycap, which simplifies the structure between the metal substrate and the keycap. At the same time, the LED light is arranged downward, which can directly dissipate heat, so as to achieve the effect of convenient heat dissipation, and then it can also benefit the notebook itself to dissipate heat and further dissipate heat from the keyboard.

In order to solve this technical problem, the technical solution that the present application adopts is: a backlight module for five-in-one metal substrate backlight and conductive film combined keyboard, comprising keycaps, upper conduction components, lower conduction components, LED lights, light shielding film, light guiding film and light reflecting film, wherein the keycap is arranged above the upper conduction component, and the lower conduction component is arranged below the upper conduction component, wherein an opening is provided on the lower conduction component corresponding to the position of the keycap, and the LED light is arranged under the lower conduction component, wherein the light shielding film is arranged under the lower conduction component, and the light shielding film is provided with a first through hole corresponding to the LED light, wherein the light guiding film is arranged under the light shielding film, and the light guiding film is provided with a second through hole corresponding to the LED light, wherein the LED lights are arranged in the first through hole and the second through hole, and the corresponding openings on the light guiding film are provided with light guiding dots, wherein the light reflecting film is arranged under the light guiding film.

Further, the upper conduction component comprises an elastic conducting member and an insulating layer, and the insulating layer is provided with a first conductive contact, and the elastic conducting member is arranged on the insulating layer corresponding to the first conductive contact, and the first conductive contact is silver paste dot or conductor.

Further, the lower conduction component comprises an upper circuit layer, a metal substrate and a lower circuit layer, the upper circuit layer is arranged above the metal substrate, and the lower circuit layer is arranged below the metal substrate, the upper circuit layer is provided with a second conductive contact corresponding to the elastic conducting member, the LED light is arranged under the lower circuit layer, and the upper circuit layer is provided with a first opening corresponding to the position of the keycap, and the metal substrate is provided with a second opening corresponding to the first opening, and the lower circuit layer is provided with a third opening corresponding to the second opening.

Further, the upper conduction component is fixedly assembled with the lower conduction component through a first adhesive layer, and a thickness of the first adhesive layer is 0.02 mm-0.025 mm.

Further, the upper circuit layer, the metal substrate and the lower circuit layer are pasted together, Further, a thickness of the upper circuit layer and the lower circuit layer are both 0.05-0.1 mm, the upper circuit layer is configured to be black or white, and the lower circuit layer is configured to be a color that can reflect light, the metal substrate is a metal sheet, and a thickness of the metal sheet is 0.15-0.25 mm.

Further, the lower conduction component is fixedly assembled with the light-shielding film through a second adhesive layer, and a thickness of the second adhesive layer is 0.02 mm~0.025 mm; the light shielding film is fixedly assembled with the light guiding film through a third adhesive layer, and a thickness of the third adhesive layer is 0.02 mm ~0.025 mm, and the light guiding film is fixedly assembled with the light reflecting film through a fourth adhesive layer, and a thickness of the fourth adhesive layer is 0.02 mm~0.025 mm.

Further, a lower layer of the light reflecting film is provided with black ink, and an upper layer is coated with a color capable of reflecting light; the light guiding dots (102) are arranged above or below the light guiding film, and a thickness of the light guiding film is 0.010-0.25 mm.

Further, a first connection terminal is provided on one side of the upper circuit layer, and the first connection terminal is welded on the upper circuit layer, or the first connection terminal is integrally formed with the upper circuit layer, and the second connection terminal is provided on one side of the lower circuit layer.

Further, a scissor foot is arranged between the keycap and the upper conduction component, and a hook for snapping the scissor foot is provided above the metal substrate.

Beneficial effects of the present application: the application provides a backlight module for five-in-one metal substrate backlight and conductive film combined keyboard. By using the lower conduction component structure, the metal substrate is located under the keycap, so that the metal substrate is located under the keycap, which acts as a circuit substrate and directly supports the keycap. The structure between the metal substrate and the keycap is simplified by combining the conductive film (Membrane) with the lower conduction component of the metal substrate. At the same time, the LED light is arranged downward, which can directly dissipate heat through the metal substrate of the lower conduction component, so as to achieve the effect of convenient heat dissipation, and then it can also benefit the notebook itself to dissipate heat and further dissipate heat from the keyboard.

### BRIEF DESCRIPTION OF DRAWINGS

FIG. 1 is a schematic structural diagram of the disassembled state of a partial cut surface of a single keycap provided by the present application;

FIG. 2 is a schematic structural diagram of the disassembled state of single keycap and scissor foot provided by the present application;

FIG. 3 is a schematic structural diagram of the disassembled state of the lower conduction component provided by the present application;

FIG. 4 is a partial structural top view of the keycap provided by the present application;

FIG. 5 is a structural bottom view of Embodiment 1 of the lower circuit layer provided by the present application;

FIG. 6 is a structural top view of Embodiment 1 of the upper circuit layer provided by the present application;

FIG. 7 a structural bottom view of Embodiment 2 of the lower circuit layer provided by the present application;

FIG. 8 is a structural top view of Embodiment 2 of the upper circuit layer provided by the present application;

FIG. 9 is a structural bottom view of the insulating layer provided in the present application.

### REFERENCE SIGNS

1—Keycap; 2—Scissor foot; 3—Upper conduction component; 31—Elastic conducting member; 32—Insulating layer; 321—First conductive contact; 4—First adhesive layer; 5—Lower conduction component; 51—Upper circuit layer; 511—Second conductive contact; 512—First opening; 513—First terminal; 52—Metal substrate; 521—Second opening; 522—Hook; 53—Lower circuit layer ; 531—Third opening; 532—Second terminal; 6—LED light; 7—Second adhesive layer; 8—Light shading film; 81—First through hole; 9—Third adhesive layer; 10—Light guiding film; 101—Second through hole; 102—light guiding dot; 11—Fourth adhesive layer; 12—Light reflecting film.

### DETAILED DESCRIPTION

In order to make the purpose, technical solution and effect of the present application more clear and definite, the present application will be further described in detail below with reference to the accompanying drawings and examples. It should be understood that the specific embodiments described here are only used to explain the present application, not to limit the present application.

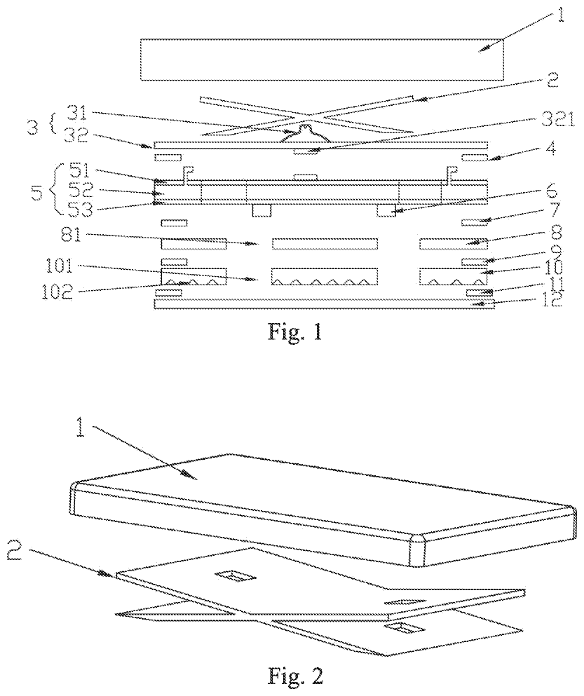

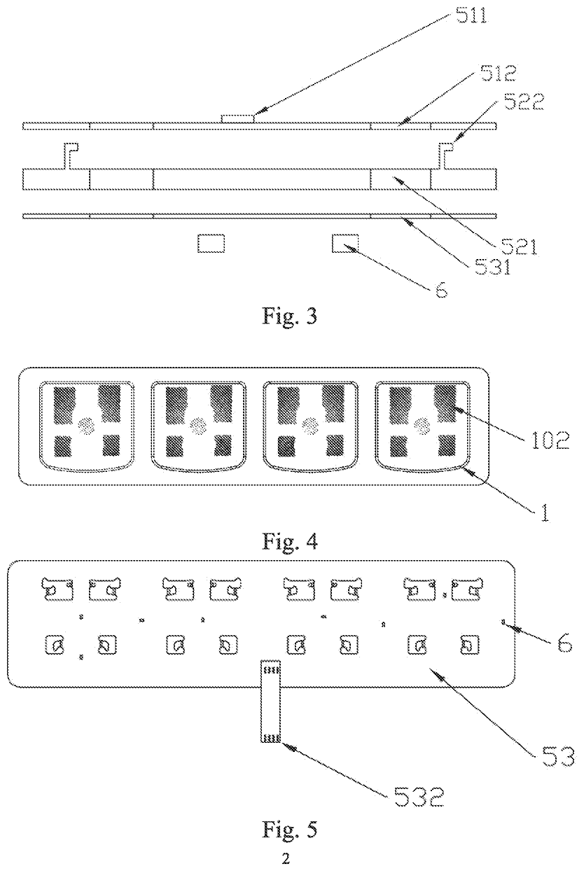

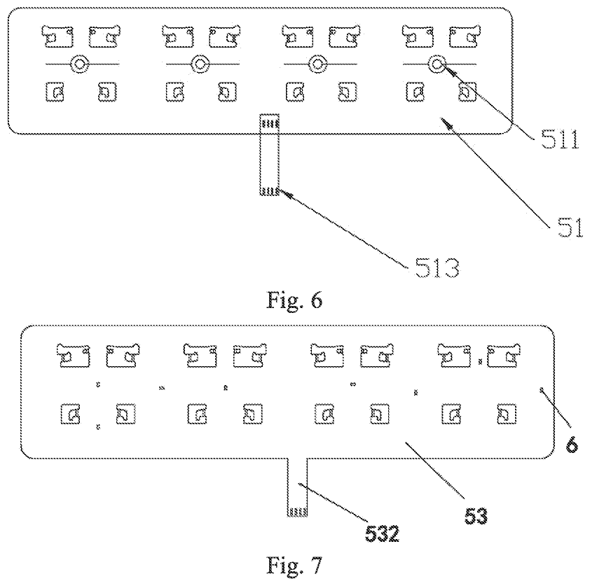

Please refer to FIGS. 1-7, a backlight module provided by the present application for a five-in-one metal substrate backlight and conductive film combined keyboard, the figure shows the structure of a single keycap of a keyboard and the structures at the keycaps during implementation are the same. The backlight module comprises keycaps 1, upper conduction components 3, lower conduction components 5, LED lights 6, light shielding film 8, light guiding film 10 and light reflecting film 12, wherein the keycap 1 is arranged above the upper conduction component 3, and the lower conduction component 5 is arranged below the upper conduction component 3. When the keycap 1 is pressed, a conduction is realized between the upper conduction component 3 and the lower conduction component 5, wherein the LED light 6 is arranged under the lower conduction component 5, wherein the LED lamp 6 is a top-emitting type or a side-emitting type. At this time, the LED light is on. An opening is provided on the lower conduction component 5 corresponding to the position of the keycap 1 for light to pass through. The light shielding film 8 is arranged below the lower conduction component 5, and the light shielding film 8 has two functions of light reflecting and light shielding, wherein the light shielding film (8) is arranged under the lower conduction component (5), and the light shielding film 8 is provided with a first through hole 81 corresponding to the LED light 6, wherein the light guiding film 10 is arranged under the light shielding film 8, and the light guiding film 10 is provided with a second through hole 101 corresponding to the LED light 6, wherein the LED lights 6 are arranged in the first through hole 81 and the second through hole 101, and the corresponding openings on the light guiding film 10 are provided with light guiding dots 102, wherein the light reflecting film 12 is arranged under the light guiding film 10. In this way, the light emitted by the LED light 6 can be illuminated into the light guiding film 10, and then emitted from the light guiding dots 102, thereby illuminating the keycap 1. By arranging the LED light 6 downward, heat can be directly dissipated, thereby achieving the effect of convenient heat dissipation, and further benefiting the heat dissipation of the notebook itself to further dissipate heat from the keyboard.

In this embodiment, the upper conduction component 3 comprises an elastic conducting member 31 and an insulating layer 32, wherein the insulating layer 32 is made of PET (polyethylene terephthalate) material, and the elastic conducting member 31 is a shrapnel or Rubber Domes. The insulating layer 32 is provided with a first conductive contact 321, and the elastic conducting member 31 is arranged on the insulating layer 32 corresponding to the first conductive contact 321, and the first conductive contact 321 is other conductive materials such as silver paste dot or conductor. The insulating layer 32 and the first conductive contact 321 form a conductive film (Membrane), so as to facilitate conduction. The lower conduction component 5 comprises an upper circuit layer 51, a metal substrate 52 and a lower circuit layer 53, the upper circuit layer 51 is arranged above the metal substrate 52, the lower circuit layer 53 is arranged below the metal substrate 52, and the upper circuit layer 51 and the lower circuit layer 53 is preferably a copper foil line. The upper circuit layer 51 is provided with a second conductive contact 511 corresponding to the elastic conducting member 31. The second conductive contact 511 is other conductive materials such as silver paste points or conductors. the LED light 6 is arranged under the lower circuit layer 53, and the upper circuit layer 51 is provided with a first opening 512 corresponding to the position of the keycap 1, and the metal substrate 52 is provided with a second opening 521 corresponding to the first opening 512, and the lower circuit layer 53 is provided with a third opening 531 corresponding to the second opening 521. This makes the metal substrate 52 directly under the keycap 1 and directly supports the keycap 1, thereby simplifying the structure between the metal substrate 52 and the keycap 1, which is beneficial to increase the hand feeling during use.

In this embodiment, in order to carry out signal transmission between the backlight module and the notebook, a first connection terminal 513 is provided on one side of the upper circuit layer 51, and the signal is transmitted through the first connection terminal 513 after pressing, and a second connection terminal 532 is provided on one side of the lower circuit layer 53, and the LED light signal is controlled through the first connection terminal 513, wherein the first connection terminal 513 is connected to the upper circuit layer 51 by welding, and the second connection terminal 532 can also be connected to the lower circuit layer 53 by welding.

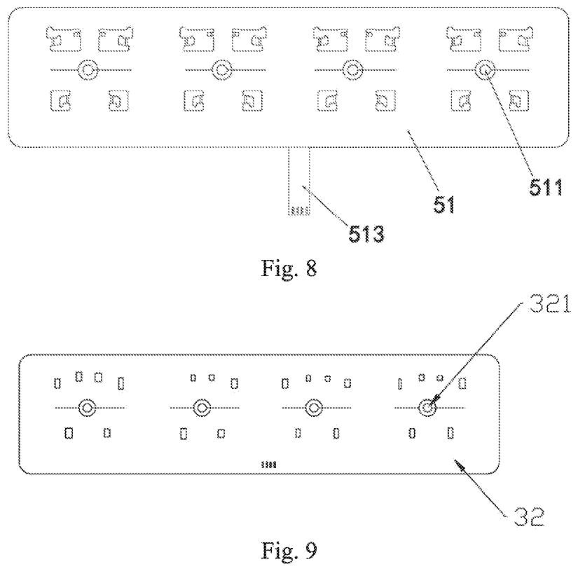

In the above embodiments, the first connection terminal 513 is connected to the upper circuit layer 51 by welding. During specific implementation, the first connecting terminal 513 can also be integrally arranged with the upper circuit layer 51, please refer to the structure as shown in FIG. 7 and FIG. 8.

In this embodiment, the upper conduction component 3 is fixedly assembled with the lower conduction component 5 through a first adhesive layer 4, and a thickness of the first adhesive layer 4 is 0.02 mm-0.025 mm, so the upper conduction component 3 and the lower conduction component 5 can be regarded as one. The first adhesive layer 4 is thermosetting adhesive, self-adhesive, etc., through which the overall assembly is carried out, which is convenient for integrated transportation and production. It is also possible not to use the first adhesive layer 4, and at the same time achieve the purpose of optimizing the structure of the backlight module, thereby increasing the compactness of the structure.

In this embodiment, the upper circuit layer 51, the metal substrate 52 and the lower circuit layer 53 are pasted together, or can be made into an integrated structure, and can be pasted together with thermosetting glue or self-adhesive.

In this embodiment, the light shielding film 8 is made of PET (polyethylene terephthalate), and the light guiding film 10 and the light reflecting film 12 can also be made of PET (polyethylene terephthalate). Thickness is 0.020~0.30 mm, preferably 0.025 mm, and it can also be made of other materials during specific implementation. The lower layer of the light shielding film 8 is provided with white ink for light reflecting, so that the upward light emitted by the LED light 6 can be reflected back into the light guiding film 10 to enhance its brightness. The upper layer of the light shielding film 8 is provided with black ink, which is used for light shielding, so as to prevent other areas except the position of the keycap 1 from being transmitted through, and affect the overall use effect of the keyboard. In this embodiment, the white ink and the black ink are arranged on the light shielding film 8 by printing, and other methods can also be selected for actual implementation, such as: spraying, silk screen printing and the like.

In this embodiment, the thicknesses of the upper circuit layer 51 and the lower circuit layer 53 are both 0.05-0.1 mm, the color of the upper circuit layer 51 is black or white, and the lower circuit layer 53 has a color that can reflect light, such as white, transparent color. Adopting transparent color is to reflect light by the color of the metal sheet itself, the color of the upper circuit layer 51 and the lower circuit layer 53 are both white, and the color of the lower circuit layer 53 can also be white to play a reflective effect. In the specific implementation, the position of the pad of the component avoids the white area, and any side of the four sides of the lower circuit layer can be provided with a pad. The metal substrate 52 is a metal sheet, such as steel sheet, aluminum alloy, etc., wherein the thickness of the steel sheet is 0.15-0.25 mm to ensure the thickness of the backlight module.

In this embodiment, the lower conduction component 5 is fixedly assembled with the light-shielding film 8 through a second adhesive layer 7, and a thickness of the second adhesive layer 7 is 0.02 mm-0.025 mm; the light shielding film 8 is fixedly assembled with the light guiding film 10 through a third adhesive layer 9, and a thickness of the third adhesive layer 9 is 0.02 mm~0.025 mm, and the light guiding film 10 is fixedly assembled with the light reflecting film 12 through a fourth adhesive layer 11, and a thickness of the fourth adhesive layer 11 is 0.02 mm~0.025 mm. The second adhesive layer 7, the third adhesive layer 9 and the fourth adhesive layer 11 are thermosetting adhesives, which are convenient for processing. During specific implementation, materials such as self-adhesive can also be selected, and its thickness is negligible, as long as it meets the bonding requirements. Alternatively, during production and processing, the second adhesive layer 7, the third adhesive layer 9 and the fourth adhesive layer 11 are not provided, and other fixing structures are selected for fixing between them.

In this embodiment, the lower layer of the light reflecting film 12 is provided with black ink, which can have a good light shielding effect and is conducive to improving the overall use effect of the keyboard without exposure to light. The upper layer is coated with a color that can reflect light, for example white, fluorescent white, etc.

In this embodiment, the light guiding dots 102 can be produced by conventional methods such as coating, silk screen printing, dot printing, UV glue or embossing. The light guiding dots 102 are arranged above or below the light guiding film 10, preferably at positions where the light guiding dots 102 correspond to the openings, and the thickness of the light guiding film 10 is 0.0125-0.25 mm.

In this embodiment, a scissor foot 2 is arranged between the keycap 1 and the upper conduction component 3, and a hook 522 for snapping the scissor foot 2 is provided above the metal substrate 52. The upper conduction component 3 is provided with a through hole for the hook 522 to pass through (not shown in the drawings). In a specific implementation, by pressing the keycap 1, pressure is applied to the scissors foot 2, so that the elastic conducting member 31 is deformed under force, so that the insulating layer 32 is stressed, thereby the first conductive contact 321 is connected to the second conductive contact 511 to achieve the effect of pressing the button. After the keycap 1 is released, the scissors foot and the elastic conducting member 31 rebound, so that the first conductive contact 321 is separated from the second conductive contact 511 thereby breaking the conduction.

It should be understood that the application of the present application is not limited to the above examples, and those skilled in the art can make improvements or changes based on the above descriptions, and all these improvements and changes should belong to the protection scope of the appended claims of the present application.

What is claimed is:

1. A backlight module for five-in-one metal substrate backlight and conductive film combined keyboard, comprising keycaps (1), upper conduction components (3), lower conduction components (5), LED lights (6), light shielding film (8), light guiding film (10) and light reflecting film (12), wherein the keycap (1) is arranged above the upper conduction component (3), and the lower conduction component (5) is arranged below the upper conduction component (3), wherein an opening is provided on the lower conduction component (5) corresponding to the position of the keycap (1), and the LED light (6) is arranged under the lower conduction component (5), wherein the light shielding film (8) is arranged under the lower conduction component (5), and the light shielding film (8) is provided with a first through hole (81) corresponding to the LED light (6), wherein the light guiding film (10) is arranged under the light shielding film (8), and the light guiding film (10) is provided with a second through hole (101) corresponding to the LED light (6), wherein the LED lights (6) are arranged in the first through hole (81) and the second through hole (101), and the corresponding openings on the light guiding film (10) are provided with light guiding dots (102), wherein the light reflecting film (12) is arranged under the light guiding film (10).

2. The backlight module for five-in-one metal substrate backlight and conductive film combined keyboard according claim 1, wherein the upper conduction component (3) comprises an elastic conducting member (31) and an insulating layer (32), and the insulating layer (32) is provided with a first conductive contact (321), and the elastic conducting member (31) is arranged on the insulating layer (32) corresponding to the first conductive contact (321), and the first conductive contact (321) is silver paste dot or conductor.

3. The backlight module for five-in-one metal substrate backlight and conductive film combined keyboard according claim 1, wherein the lower conduction component (5) comprises an upper circuit layer (51), a metal substrate (52) and a lower circuit layer (53), the upper circuit layer (51) is arranged above the metal substrate (52), and the lower circuit layer (53) is arranged below the metal substrate (52), the upper circuit layer (51) is provided with a second conductive contact (511) corresponding to the elastic conducting member (31), the LED light (6) is arranged under the lower circuit layer (53), and the upper circuit layer (51) is provided with a first opening (512) corresponding to the position of the keycap (1), and the metal substrate (52) is provided with a second opening (521) corresponding to the first opening (512), and the lower circuit layer (53) is provided with a third opening (531) corresponding to the second opening (521).

4. The backlight module for five-in-one metal substrate backlight and conductive film combined keyboard according claim 1, wherein the upper conduction component (3) is fixedly assembled with the lower conduction component (5) through a first adhesive layer (4), and a thickness of the first adhesive layer (4) is 0.02 mm-0.025 mm.

5. The backlight module for five-in-one metal substrate backlight and conductive film combined keyboard according claim 3, wherein the upper circuit layer (51), the metal substrate (52) and the lower circuit layer (53) are pasted together.

6. The backlight module for five-in-one metal substrate backlight and conductive film combined keyboard according claim 3, wherein a thickness of the upper circuit layer (51) and the lower circuit layer (53) are both 0.05-0.1 mm, the upper circuit layer (51) is configured to be black or white, and the lower circuit layer (53) is configured to be a color that can reflect light, the metal substrate (52) is a metal sheet, and a thickness of the metal sheet is 0.15-0.25 mm.

7. The backlight module for five-in-one metal substrate backlight and conductive film combined keyboard according claim 1, wherein the lower conduction component (5) is fixedly assembled with the light-shielding film (8) through a second adhesive layer (7), and a thickness of the second adhesive layer (7) is 0.02 mm~0.025 mm; the light shielding film (8) is fixedly assembled with the light guiding film (10) through a third adhesive layer (9), and a thickness of the third adhesive layer (9) is 0.02 mm~0.025 mm, and the light guiding film (10) is fixedly assembled with the light reflecting film (12) through a fourth adhesive layer (11), and a thickness of the fourth adhesive layer (11) is 0.02 mm~0.025 mm.

8. The backlight module for five-in-one metal substrate backlight and conductive film combined keyboard according claim 1, wherein a lower layer of the light reflecting film (12) is provided with black ink, and an upper layer is coated with a color capable of reflecting light; the light guiding dots (102) are arranged above or below the light guiding film (10), and a thickness of the light guiding film (10) is 0.010-0.25 mm.

9. The backlight module for five-in-one metal substrate backlight and conductive film combined keyboard according claim 1, wherein a first connection terminal (513) is provided on one side of the upper circuit layer (51), and the first connection terminal (513) is welded on the upper circuit layer (51), or the first connection terminal (513) is integrally formed with the upper circuit layer (51), and the second connection terminal (532) is provided on one side of the lower circuit layer (53).

10. The backlight module for five-in-one metal substrate backlight and conductive film combined keyboard according claim 3, wherein a scissor foot (2) is arranged between the keycap (1) and the upper conduction component (3), and a hook (522) for snapping the scissor foot (2) is provided above the metal substrate (52).
